(19) United States
(12) Patent Application Publication
(10) Pub. No.: US 2017/0135528 A1
(43) Pub. Date: May 18, 2017

(54) CUBICLE SAFETY SHOWER

(71) Applicant: Alpine Technical Services, LLC, Midvale, UT (US)

(72) Inventors: Richard E. Allred, Highland, UT (US); Michael Armatage, Alpine, UT (US)

(73) Assignee: Alpine Technical Services, LLC, Midvale, UT (US)

(21) Appl. No.: 15/192,445

(22) Filed: Jun. 24, 2016

Related U.S. Application Data
(60) Provisional application No. 62/256,640, filed on Nov. 17, 2015.

(51) Int. Cl. A47K 3/28; A61H 35/02; E04H 1/12

(52) U.S. Cl. CPC A47K 3/28; E04H 1/1266; E04H 1/1277; E04H 1/1216; A61H 35/02

(57) ABSTRACT

The disclosure extends to safety response systems, methods and devices, and more particularly, but not necessarily entirely, to a safety shower and/or safety eyewash bath or unit as well as a pre-cast shower base used in connection with a safety shower and/or eyewash bath or unit, which may be used in various industries that require such safety showers or safety eyewash equipment.

### CROSS-REFERENCE TO RELATED APPLICATIONS

This application claims the benefit of U.S. Provisional Application No. 62/256,640, filed Nov. 17, 2015, which is hereby incorporated by reference herein in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### STATEMENT REGARDING FEDERALLY SPONSORED RESEARCH OR DEVELOPMENT

Not Applicable.

### BACKGROUND

The disclosure relates generally to safety response systems, methods and devices, and more particularly, but not necessarily entirely, to a cubicle safety shower and safety eyewash unit, which may be used in various industries that require such safety showers or safety eyewash equipment.

In many fields where the eyes or body of any person may be exposed to injurious corrosive materials it is a requirement to have emergency eyewashes and showers nearby. More specifically, in any industry in which such exposure is possible, it is a requirement to provide suitable facilities for quick drenching or flushing of the eyes and body. The emergency equipment must be located within or near the work area for immediate emergency use. According to at least one safety standard, an eyewash and/or safety shower would be required where an employee's eyes or body could be exposed to injurious corrosive materials. If none of the materials used in the work area is an injurious corrosive chemical or material (as indicated by the Safety Data Sheet (SDS) for each product), then an emergency eyewash or shower would not be required.

The current standard addressing emergency eyewash and shower equipment provides for eyewash and shower equipment in appropriate situations when employees are exposed to hazardous materials. Hazardous materials include caustics, as well as additional substances and compounds that have the capability of producing adverse effects on the health and safety of humans. The safety standards also provide details with respect to the location, installation, nature, and maintenance of eyewash and shower equipment.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The features and advantages of the disclosure will become apparent from consideration of the description and accompanying drawings where:

FIG. 1 is a front, perspective view of an implementation of a safety shower made in accordance with the teachings and principles of the disclosure;

FIG. 2 is a floor plan view of an implementation of a safety shower made in accordance with the teachings and principles of the disclosure;

FIG. 3 is a front view illustrating internal components of an implementation of a safety shower made in accordance with the teachings and principles of the disclosure;

FIG. 4 is a front view of an implementation of a safety shower made in accordance with the teachings and principles of the disclosure;

FIGS. 5-8 illustrate various views of an implementation of a safety shower made in accordance with the teachings and principles of the disclosure;

FIG. 9-10 illustrate various views of an implementation of a safety shower made in accordance with the teachings and principles of the disclosure;

FIG. 11 illustrates a plan view of a pre-cast shower base used in connection with a safety shower and made in accordance with the teachings and principles of the disclosure;

FIG. 12 is a prior art open safety shower; and

FIG. 13 is a prior art enclosed safety shower for a single human.

### DETAILED DESCRIPTION

The disclosure extends to safety response systems, methods and devices, and more particularly, but not necessarily entirely, to a safety shower and/or safety eyewash bath or unit as well as a pre-cast shower base used in connection with a safety shower and/or eyewash bath or unit, which may be used in various industries that require such safety showers or safety eyewash equipment. In the following description of the disclosure, reference is made to the accompanying drawings, which form a part hereof, and in which is shown by way of illustration specific implementations in which the disclosure may be practiced. It is understood that other implementations may be utilized and structural changes may be made without departing from the scope of the disclosure.

When the need arises for using the emergency safety showers or eyewash equipment, it is often due to exposure to hazardous materials that corrode and continue to burn through clothing worn by the affected person. Thus, it is often the case that a person using the equipment must enter the shower and remove all clothing, including footwear, exposed to the hazardous material. Because these emergency showers are to be located on the working premises, safety showers in the marketplace are made as small as possible, while still meeting the required regulations, such that only a single person may fit inside. Often this makes it difficult or impossible for emergency personnel or others to assist the person who has been exposed to the hazardous material. In many circumstances, the exposed person is unable to assist themselves because of injury, whether to the eyes, face, or other part of the body, which makes helping oneself difficult or impossible. Thus, safety showers in the marketplace that allow only the exposed individual into the safety shower may pose a substantial risk to such exposed individuals because there is no ability to help or otherwise assist that person in the safety shower.

What is needed is a safety shower, and safety shower system, that provides the ability and room for at least one additional person to assist a person exposed to hazardous materials; that provides safety for a person who has need to use such a safety shower or safety eyewash because clothing with hazardous material or chemical burns will continue to burn a person while clothing is on, such that the removal and change of clothes is essential; and that provides a system and method for not re-contaminating an environment or the person who has been exposed to hazardous materials. Further what is needed is a safety shower system that provides the ability and room for at least one additional person to assist a person exposed to hazardous materials without unnecessarily endangering the assisting person by forcing the assisting person to be in very close proximity with, for example, the hazardous materials being washed off the exposed person and the clothing removed from the exposed person. As will be seen, the disclosure provides such a safety shower and safety shower system in an effective and elegant manner.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

It is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting.

In describing the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or material not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

It will be appreciated that various safety regulations require that whenever a person gets contaminated by hazardous materials, whether in a fluidic state or a solid state, and the material cannot be readily removed, for example by washing the person's hands or the material is splashed into the employee's eyes, then eyewash baths or units and/or safety showers should be used. Such safety showers and eyewashes are used to keep the hazardous material or contaminant from entering the person's skin. Safety showers and eyewashes are the first line of treatment for accidental contamination of the body and eyes of individuals working with hazardous materials.

Referring now to the figures, there are illustrated various implementations of the safety shower of the disclosure.

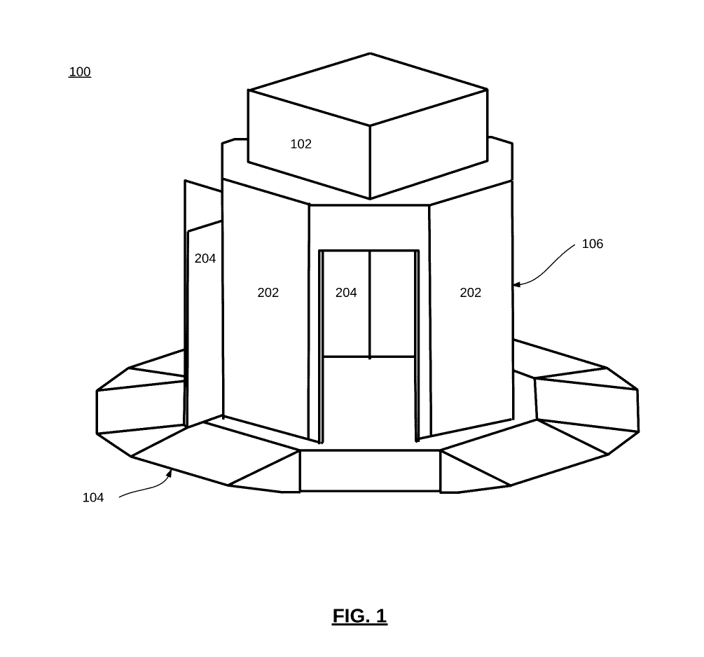

FIG. 1 is a front, perspective view of an implementation of a safety shower 100 made in accordance with the teachings and principles of the disclosure. The safety shower 100 may comprise an enclosed cubicle 106 that is depicted in the figure as a polygonal shape. The shape of the safety shower 100 can be designed to optimize the wind load rating of the safety shower as well as to maximize the space inside the cubicle 106. For example, a hexagonal or octagonal shape may maximize the interior space of the safety shower while also providing sufficient wall space for additional features such as, for example, a bench, eyewash station, showerhead, clothes rack, etc., and providing for a plurality of entrances into the enclosed cubicle 106. The safety shower 100 may comprise a tank 102 as the liquid supply source. The tank may be located above the enclosed cubicle 106 and attached to the enclosed cubicle 106 such that the liquid may be gravity-fed into the safety shower. Alternatively, the tank may be located remotely and connected to the safety shower 100 with a pump. Alternatively, the safety shower 100 may be configured to be direct-plumbed and may not include a tank 102, or the safety shower 100 may be configured to be direct-plumbed and also include a backup tank 102 for use when the direct-plumbed liquid source is nonfunctional. Further, the tank 102 may be located on top of the shower, or it may be connected to a pump and located in any other suitable location. The safety shower 100 may further comprise a plurality of doors 204 and walls 202 that define the shape of the enclosed cubicle 106. In one embodiment of the disclosure, the doors 204 are double swing doors that enable the victim and any assisting personnel to easily enter and exit the safety shower without the need to operate a doorknob or use their hands in any way. The doors 204 may further be insulated to help maintain a comfortable temperature inside the safety shower and/or protect persons using the shower from outside contaminants. The doors 204 may further be spring-loaded to enable persons to quickly enter and exit the safety shower without manually closing the doors. These features can be important for the safe and efficient operation of the shower when a victim is seriously injured.

The safety shower 100 further can include an above-grade foundation or pre-cast base 104 connected to and supporting the safety shower. The above-grade foundation 104 reduces the cost and difficulty of installation of the safety shower by eliminating the need to excavate deep into the ground to construct a below-grade foundation. An above-ground foundation may be necessary at some sites where it may be dangerous to excavate the ground at that site, but the safety shower must still sit on a stable foundation capable of supporting the weight of the safety shower. Further, the above-grade foundation ensures that previously installed below-grade piping and wiring systems remain intact and are unaffected by the installation of the safety shower. The foundation is necessary for proper support of the safety shower 100, which may include a tank 102 that when filled with liquid is very heavy and may be about 4,000 pounds or more when filled to capacity. Further, the above-grade foundation 104 can ensure that the safety shower is capable of withstanding seismic activity and/or strong wind gusts. The above-grade foundation 104 may be constructed of cement or any other durable and rigid material and reinforced with steel rebar that conforms to safety standards for a foundation. In one embodiment, the above-grade foundation or pre-cast base provides sufficient support and stability to the safety shower such that the safety shower can withstand significant seismic activity, wind speeds, and other inclement environmental conditions. In one embodiment, the above-grade foundation or pre-cast base is configured to drain used liquid, and further configured to hold used liquid such that hazardous material cannot

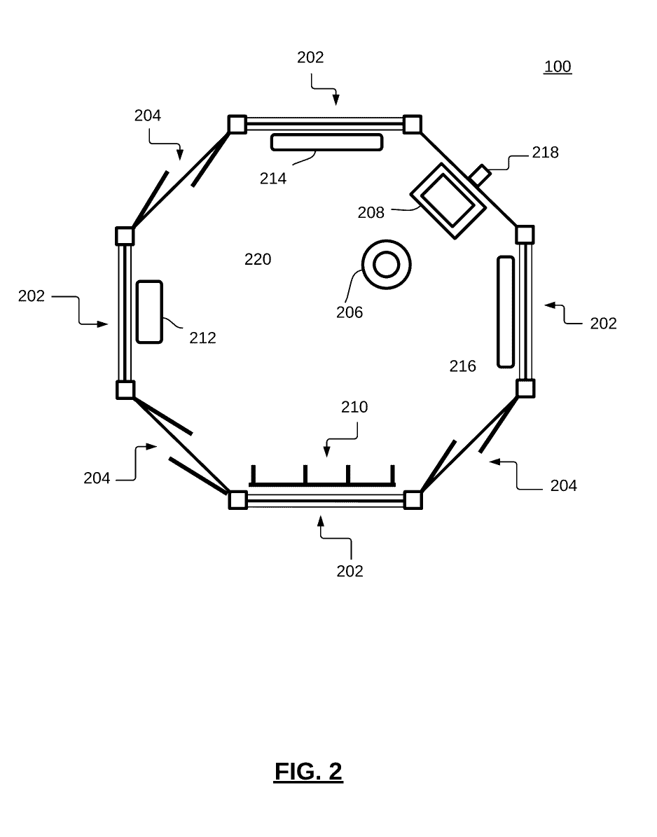

FIG. 2 is a floor plan view of an implementation of a safety shower 100 made in accordance with the teachings and principles of the disclosure. In one embodiment, the safety shower may be constructed in an octagonal shape, but the shower may be constructed in any suitable polygonal shape without departing from the scope of the disclosure. In one embodiment of the disclosure, the safety shower 100 includes a plurality of doors 204 and walls 202. The safety shower may be constructed in a polygonal shape such that the doors 204 and walls 202 alternate around the perimeter of the shower, as depicted in FIG. 2. The doors may be double swing doors 204 as depicted in FIG. 2. However, it will be appreciated that the doors may open in a single direction without departing from the scope of the disclosure. The safety shower 100 includes a showerhead 206 and an eyewash station 208 with a liquid outlet 218 for drainage of any used liquid. The showerhead 206 may be any showerhead known in the art, but one embodiment of the present disclosure utilizes the Showers & Eyebaths Services safety showerhead manufactured by the corporation of the same name. The eyewash station 208 may be any eyewash station known in the art, but one embodiment of the present disclosure utilizes the GEB1 eyewash station manufactured by the Showers & Eyebaths Services Corporation. The safety shower 100 can further include a coat rack or hooks 210, a bench or seat 212, and one or more cubicle heaters or air conditioners 214 and 216. The floor 220 of the safety shower 100 can be constructed of a heavy-duty grate that allows for drainage of any used liquid. The heavy-duty grate may also be luminous at night such that the safety shower flooring is easy for the victim and any assisting personnel to detect. The used liquid can exit the safety shower through the liquid outlet 218 after it has passed through a drain in the floor 220.

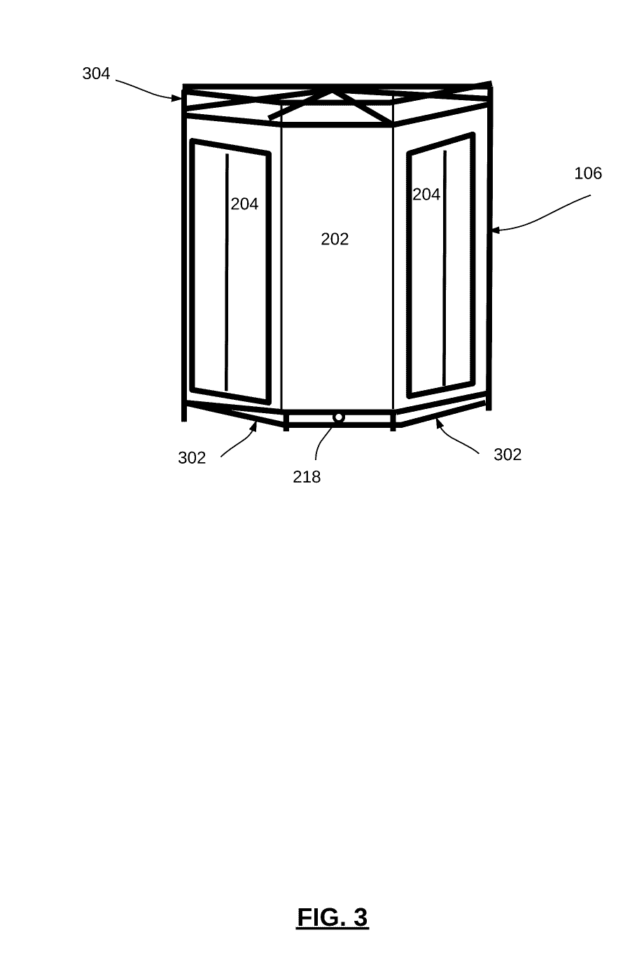

FIG. 3 is a front view illustrating internal components of an implementation of a safety shower made in accordance with the teachings and principles of the disclosure. In one embodiment, the safety shower includes an underfloor waste containment or drain sump 302 and a liquid outlet 218 for collecting and draining any used liquid. For example, the used liquid may pass through a heavy-duty grate floor 220, collect in the underfloor waste containment 302, and exit the shower through the liquid outlet 218 to drain into the ground or an installed plumbing system. In an embodiment, the drain sump 302 may collect and hold used liquid that may comprise hazardous materials. This may be particularly useful where the used liquid comprises hazardous chemicals that may harm the surrounding environment. The underfloor waste containment 302 may be sloped such that the liquid will quickly drain through the liquid outlet 218. The space above a ceiling of the enclosed cubicle 106 includes a space for piping 304 or other plumbing located directly below where a tank 102 would be located in a gravity-fed version.

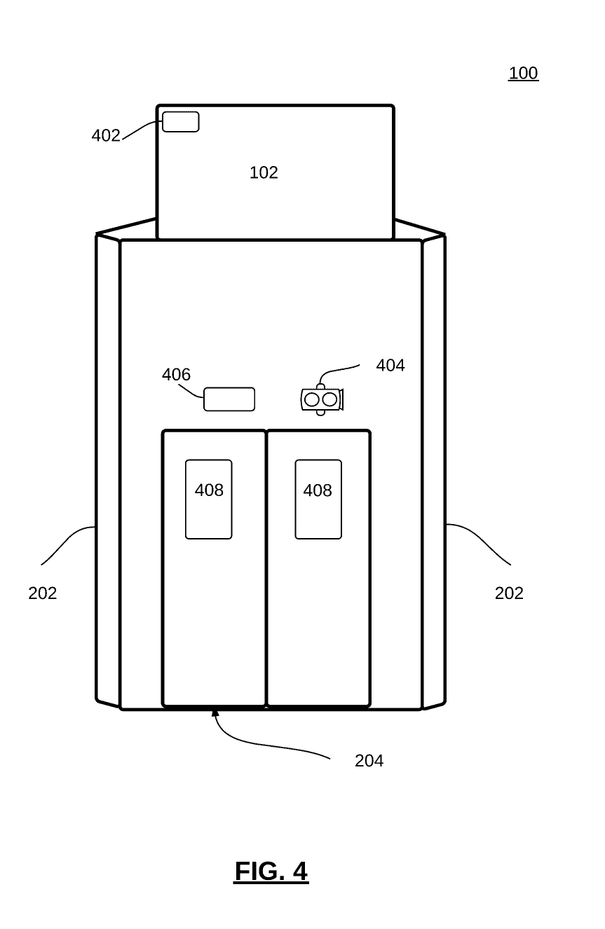

FIG. 4 is a front view of an implementation of a safety shower made in accordance with the teachings and principles of the disclosure. The safety shower 100 includes a visual level indicator 402 in the tank 102 such that a user or other personnel can quickly check the liquid levels in the tank 102. The safety shower may comprise one or more double swing doors 204. Alternatively, the safety shower may comprise one or more single swing doors 204. The doors 204 include windows 408 that enable additional personnel to check on the victim while the victim is operating the safety shower 100. Each set of the plurality of doors 204 can include windows 408 such that the victim may be viewed from multiple angles and multiple personnel may check on the victim at the same time. Further, an exterior light 406 may be installed to a wall of the enclosed cubicle 106 such that a victim or other personnel may quickly locate the safety shower 100 and visualize any obstacles around the shower. The safety shower 100 further may include an audio and visual alarm 404 mounted to the enclosed cubicle 106. The alarm 404 may be configured to activate simultaneously when the shower and/or eyewash system is activated. Further, the victim may activate the alarm 404 if the victim is in distress or requires assistance while using the safety shower 100.

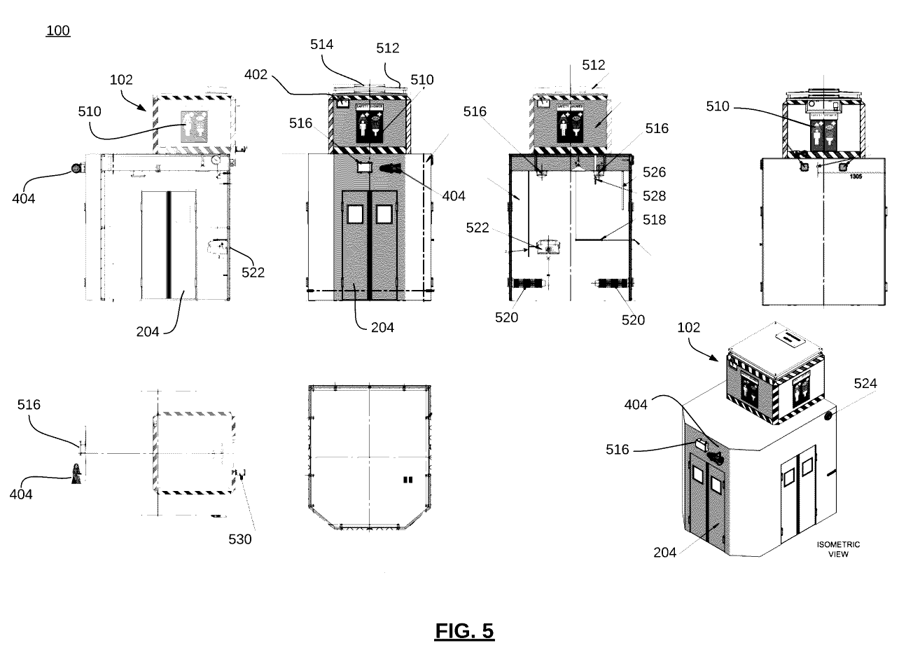

FIG. 5 illustrates various views of a safety shower in accordance with the teachings and principles of the disclosure. The safety shower 100 includes a

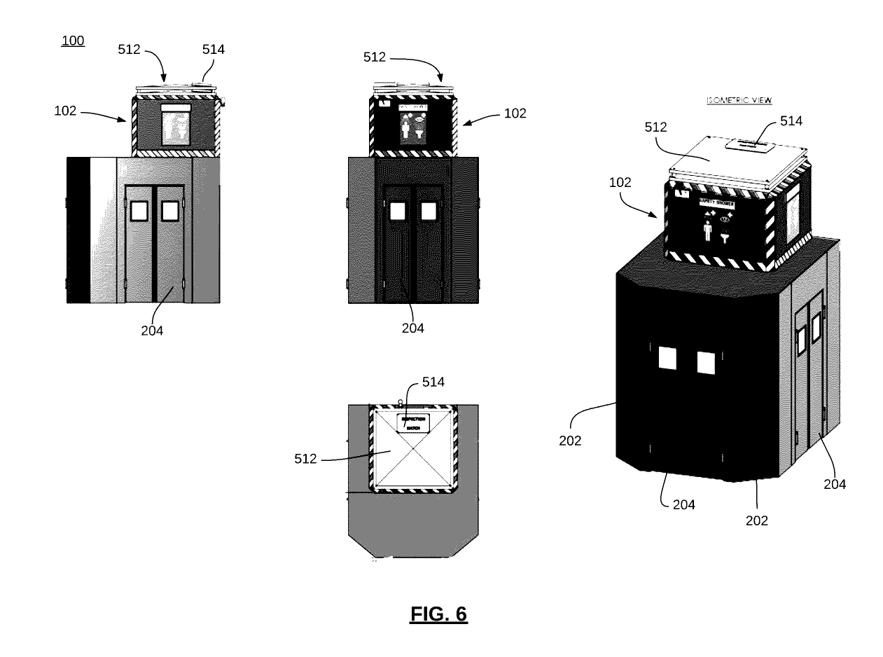

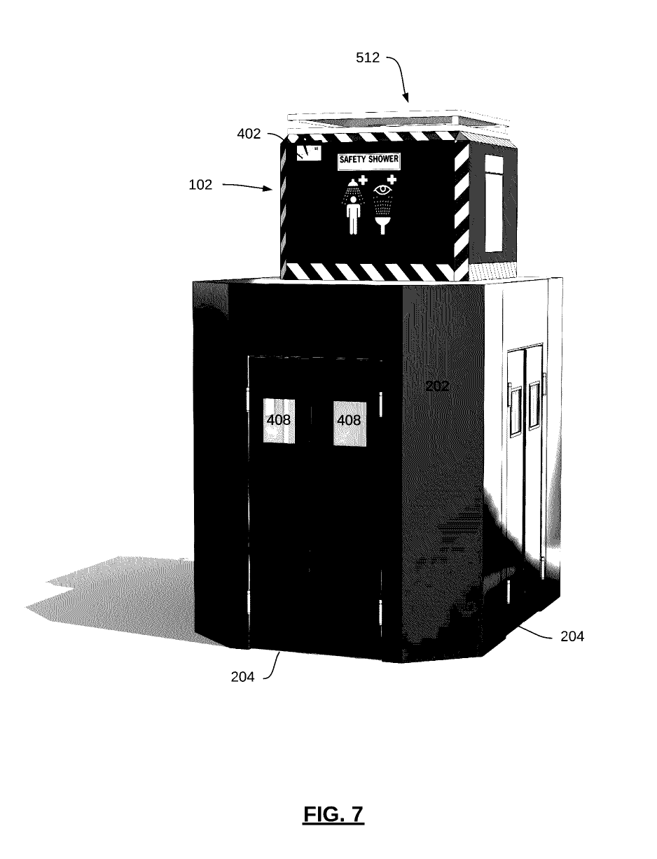

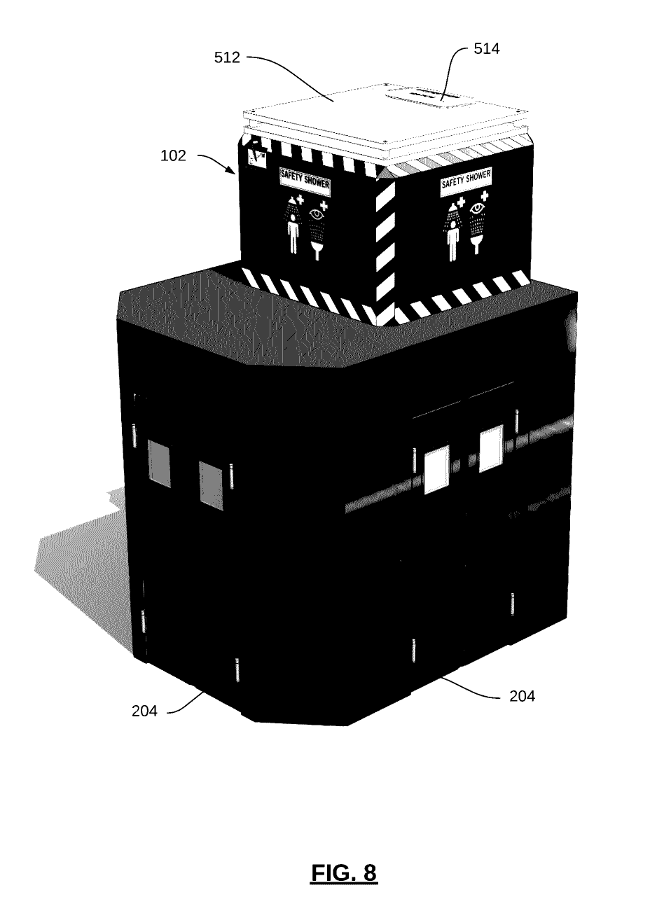

FIGS. 5-8 illustrate various views of an implementation of a safety shower. The safety shower illustrated in FIGS. 5-8 is constructed in a specialized hexagonal shape that improves wind gust resistance, provides enough space for a plurality of persons to enter the shower (e.g., a victim and at least one emergency assistant), and allows for a plurality of doors, walls, and windows such that a victim may be assisted from multiple angles. It is recognized that the hexagonal shape represents only one embodiment of the disclosure and that the disclosure can be constructed in any suitable polygonal shape. The safety shower 100 constructed in a hexagonal shape can include three sets of double-swing doors 204 with windows 408 on three sides, and three walls 202 that do not include doors 204. This allows a victim to be monitored and assisted from three directions while still providing wall space for housing, for example, an eyewash station or a seat or bench.

In one embodiment there is a pictogram sign 510 attached to the exterior of the enclosed cubicle indicating that the safety shower comprises a shower and/or eye and face wash station. The pictogram sign 510 may be constructed from a reflective material or may be lit such that a user may quickly and easily locate the safety shower. In one embodiment the safety shower comprises a sunshield roof 512 attached to the roof of the tank or the roof of the enclosed cubicle. In one embodiment the safety shower comprises an inspection hatch 514 attached to the roof of the tank or the roof of the enclosed cubicle. The inspection hatch 514 might enable a person to open the tank to inspect, for example, the purity of the liquid or the amount of liquid currently stored in the tank. The inspection hatch 514 might be constructed to include a window such that a person may inspect the liquid housed in the tank without opening the hatch. Further, the inspection hatch 514 might be constructed such that the hatch can flip open or be completely removed. The safety shower 100 may further include a temperature gauge 524 for monitoring a temperature. The temperature gauge 524 in FIG. 5 is attached to the exterior of the safety shower 100 for monitoring the exterior temperature, but the temperature gauge 524 may be located in the interior of the safety shower, in the liquid supply source, or in any other location where it may be advantageous to monitor the temperature. The temperature gauge 524 may be electronically connected to, for example, a space heater 520, a temperature dump valve, or a heater for controlling the temperature of the liquid, such as an immersion heater 530. The temperature gauge 524 may, for example, activate a space heater to control the internal temperature of the safety shower 100 or it may cause a temperature dump valve to release the liquid before the liquid freezes. In one embodiment the safety shower 100 may include a manual drain valve 528 for manually emptying the liquid supply source. A user may wish to activate the manual drain valve 528 if, for example, the liquid is in danger of freezing, the liquid is contaminated, or the liquid supply source should be emptied and refilled as part of a regular maintenance routine. In one embodiment the safety shower 100 includes a temperature valve drainpipe 526 for emptying the liquid supply source and draining the liquid when any of the exterior temperature, the interior temperature, or the temperature of the liquid reaches a specified threshold. In one embodiment the temperature valve drainpipe 526 will automatically dump the liquid when the exterior temperature reaches 40 degrees Fahrenheit.

In one embodiment the interior or exterior of the safety shower 100 might include a light 516 attached to, for example, the ceiling of the safety shower or a wall of the safety shower. The light 516 might be any light known in the art, including an energy efficient light. The light 516 might be powered by a power source known in the art, including battery power, solar power, a generator, and so forth. In one embodiment the safety shower 100 might include a panic bar 518 for safe operation of the shower. A user might, for example, use the panic bar 518 to alert nearby persons or professionals that the user is in distress and requires assistance. In such an instance, the panic bar 518 might cause the audio and visual alarm 404 to activate or it might call or otherwise notify professionals that the user requires assistance. In another embodiment, the panic bar 518 might cause the safety shower to discontinue water flow or to start water flow. In one embodiment the safety shower 100 might include a space heater or air conditioning unit 520 to heat or cool the interior of the enclosed cubicle. Control of the interior temperature of the safety shower may be particularly important in certain environments where it may be, for example, too cold to comfortably undress and shower. In one embodiment the safety shower 100 may comprise an eye and/or face wash station 522 located within the enclosed cubicle of the shower. In one embodiment the safety shower 100 comprises an immersion heater 530 that is directly immersed in the liquid supply source and is used for heating the liquid supply source. An immersion heater 530 is highly energy efficient because the heat is generated within the liquid and directly transferred to the liquid. The immersion heater 530 may be programmed to heat the liquid to a specified temperature range and maintain that temperature range. The immersion heater 530 may, for example, be programmed to maintain the liquid at a tepid temperature between, for example, about 15 Centigrade to about 38 Centigrade.

It will be appreciated that the plurality of walls of the hexagonal cubicle shape depicted in the figures are not necessarily all the same length, such that the resulting shape may be asymmetrical. It will be appreciated that a symmetrical hexagonal shape may also be utilized without departing from the scope of the disclosure. It will be appreciated that the hexagonal shape may further improve the wind resistance of the safety shower and therefore improve the structural integrity of the shower cubicle.

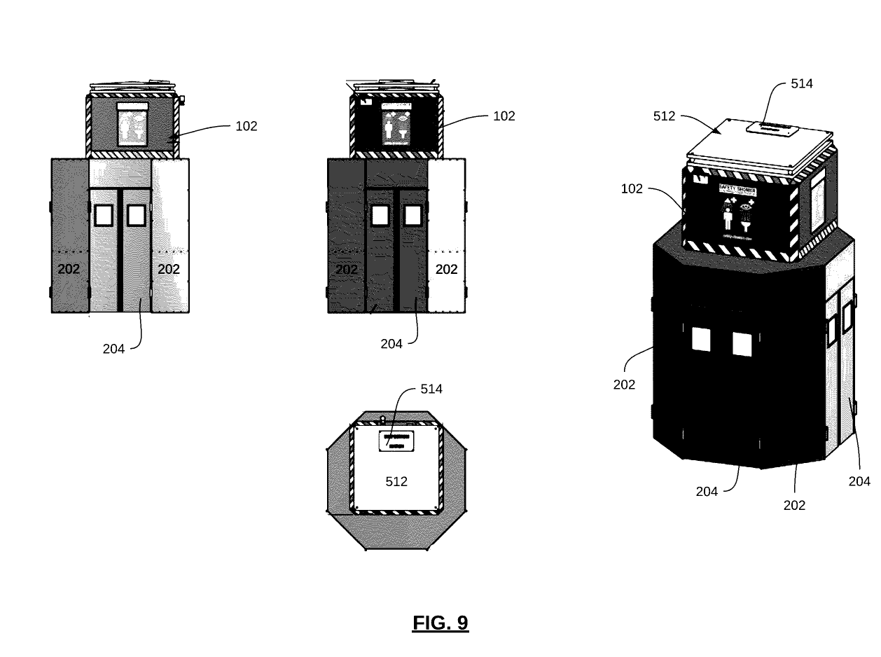

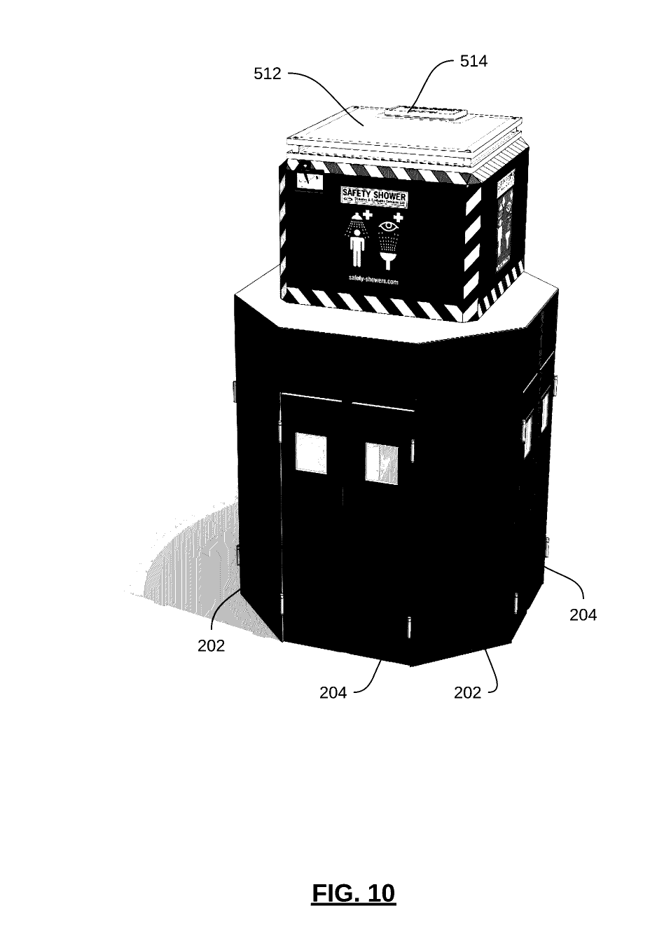

FIGS. 9-10 illustrate various views of an implementation of a safety shower. The safety shower in FIGS. 9-10 is constructed in an octagonal shape, but it is recognized that the shower can be constructed in any suitable polygonal shape. The octagonal shape can be constructed such that each of the sides and angles is equal, as depicted in FIGS. 9-10, or it can be constructed in a specialized octagonal shape with a plurality of side lengths and angles. The octagonal safety shower may be constructed with a plurality of walls comprising double-swing doors and a plurality of walls that do not include any doors. In one embodiment, the octagonal safety shower is constructed with four double-swing doors and four walls. In embodiments with a plurality of walls that each include one or more doors, it will be appreciated that a victim may be monitored and assisted by one or more persons from a plurality of angles while maintaining an abundance of wall space for installing additional features such as an eyewash station, a bench or seat, a heater, a panic bar, an alarm, etc. Further, the octagonal shape can be constructed to optimize the structural integrity of the safety shower and improve the wind resistance and seismic rating of the structure.

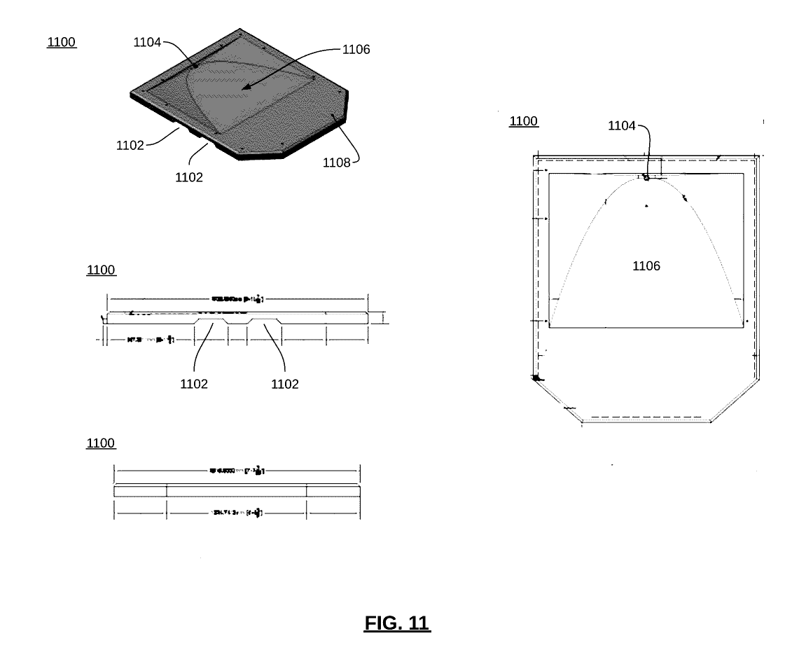

FIG. 11 illustrates various views of a pre-cast shower base 1100, including a 3D view, a side view, a front view, and a plan view of the pre-cast shower base or above-grade foundation used in connection with a safety shower. The pre-cast base 1100 (also herein referred to as an above-ground foundation) eliminates the need to excavate deep into the ground to provide a structurally adequate footing for the safety shower. The pre-cast base or above-grade foundation 1100 may be installed directly on the ground or slightly below-grade without sacrificing the structural integrity of the shower. Without the pre-cast base 1100, the safety shower can only be safely installed on a below-grade foundation that can only be laid after significant excavation, which may be difficult or undesirable in many applications. Excavation can be expensive and may damage preexisting below-grade equipment or structures, such as pipes and wiring, and it may be dangerous to attempt in some locations. For example, in some locations there may not be any reliable records indicating what structures are located below-grade and where those structures are located. In such a location it is highly desirable to support the safety shower 100 with a pre-cast above-grade foundation 1100. Further, in many locations it is highly desirable to move the safety shower 100, and with a pre-cast above-grade foundation 1100, the safety shower 100 may be relocated without excavating a new below-ground foundation. The pre-cast base or above-grade foundation 1100 as disclosed herein may reduce the cost of installation, may increase the speed of installation, and does not sacrifice safety or structural integrity of the overall safety shower or safety shower cubicle.

The pre-cast base 1100 may comprise a notch or indentation 1102 on the underside of the pre-cast base such that the base may be easily transported. For example, the pre-cast base 1100 may comprise two notches 1102 that are configured to be used by a forklift. In such an embodiment, the forklift may lift the pre-cast base, and the accompanying safety shower if it is then attached to the base, by simply inserting the forklift forks into the preformed forklift notches 1102. The notches 1102 are specifically located to minimize the risk that the unit (i.e. the pre-cast base or the pre-cast base with the accompanying safety shower attached) will fall over during transport. That is, the placement of the notches 1102 is critical to ensure that the unit may be moved safely and efficiently.

The pre-cast base 1100 may further include a drain 1104 for draining any used liquid. The drain 1104 may drain the used liquid into, for example, a collection sump, tubing for transport to a remote location, a direct sewage waste line, or directly onto the ground. The pre-cast base 1100 may comprise a sloped base 1106 configured to drain the used liquid down the slope and into the drain 1104. The pre-cast base 1100 further comprises a plurality of holes 1108 for securing the pre-cast base 1100 to the safety shower 100. The holes 1108 may comprise threading such that the pre-cast base 1100 may be screwed to corresponding holes in the enclosed cubicle of the safety shower 100. In one embodiment, the holes 1108 correspond to feet attached to the enclosed cubicle of the safety shower 100. In such an embodiment, the corresponding feet may be inserted into the holes such that the safety shower 100 may be secured to the pre-cast base 1100. In one embodiment, the corresponding feet attached to the safety shower are constructed of stainless steel and are each rated for at least 9,000 pounds of holding power. In one embodiment, the pre-cast base 1100 comprises twelve holes 1108 and the safety shower 100 comprises twelve corresponding feet. It is critical that the safety shower is firmly affixed to the pre-cast base to ensure that the safety shower is structurally sound, even during transport.

The pre-cast base may comprise a covering to encase the upper portion of the pre-cast base such that the pre-cast base may constitute the floor of the safety shower 100 but a user may comfortably stand on the covering. The covering may comprise, for example, a plastic shell with shallow ribbing to ensure that a user may stand on the pre-cast base without slipping when the base of the safety shower is wet. The covering may comprise, for example, a sealant painted directly onto the concrete pre-cast base. In one embodiment the pre-cast base itself, or a covering over the pre-cast base, may comprise internal heat elements to ensure that the floor of the safety shower is suitably warm to stand on without footwear. In one embodiment the pre-cast base 1100 does not comprise a covering and a user may stand directly on the pre-cast base 1100 when using the safety shower 100.

The pre-cast base or above-grade foundation 1100 can be constructed of any sufficiently rigid and strong material that satisfies safety standards for a foundation, but is commonly constructed of cement reinforced with rebar. The base 1100 can be constructed such that it provides a footing for the shower. Thus, the base 1100 may be larger than the footprint of the safety shower or safety shower cubicle itself. The height and area of the base 1100 may be determined based on the dimensions and weight of the safety shower cubicle. For example, a taller safety shower will require a taller (i.e. thicker) base 1100 to ensure that the tall safety shower may withstand strong wind gusts. Further, a safety shower having a gravity-fed liquid storage tank attached to the top of the shower cubicle will require a stronger base 1100 to support the weight of the safety shower and the filled liquid storage tank. The height of the base 1100 can be determined by a number of factors, including the weight of the shower, the strength of the base material, the wind gusts common at the installation site, and the seismic activity common at the installation site, to ensure that the safety shower is safely and securely installed at the site. In one embodiment the base 1100 is five inches thick and can withstand a maximum wind load of 185 miles-per-hour for a three second gust. In one embodiment the base 1100 is eight inches thick and can withstand a maximum wind load of 205 miles-per-hour for a three second gust. The base 1100 can further include electrical heat trays that are integrated in the cement for warming the safety shower and preventing the liquid and any shower components from freezing.

The base 1100 can further be constructed to include at least one step up from the ground to the entrance of the shower to ensure that users can easily enter the shower. Further, the base 1100 can be constructed with a ramp from the ground to the entrance of the shower such that a victim may be transported to the shower on, for example, a wheelchair or gurney. The base 1100 can further be constructed to ensure compliance with the accessibility requirements found in the United States' American with Disabilities Act.

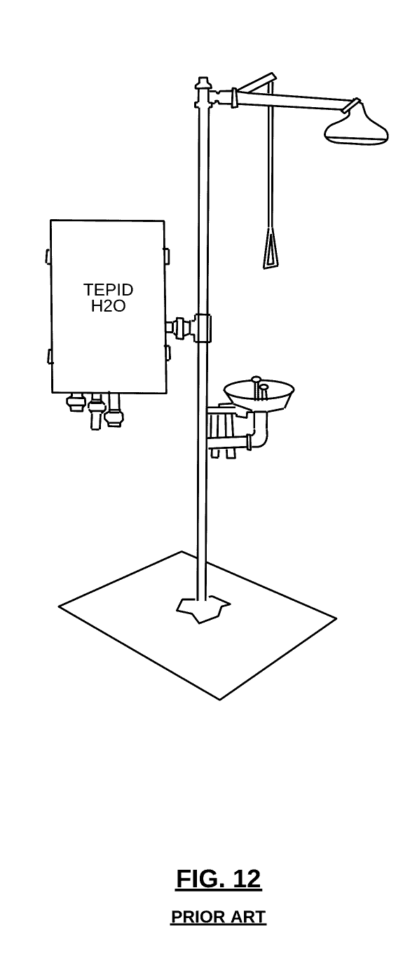

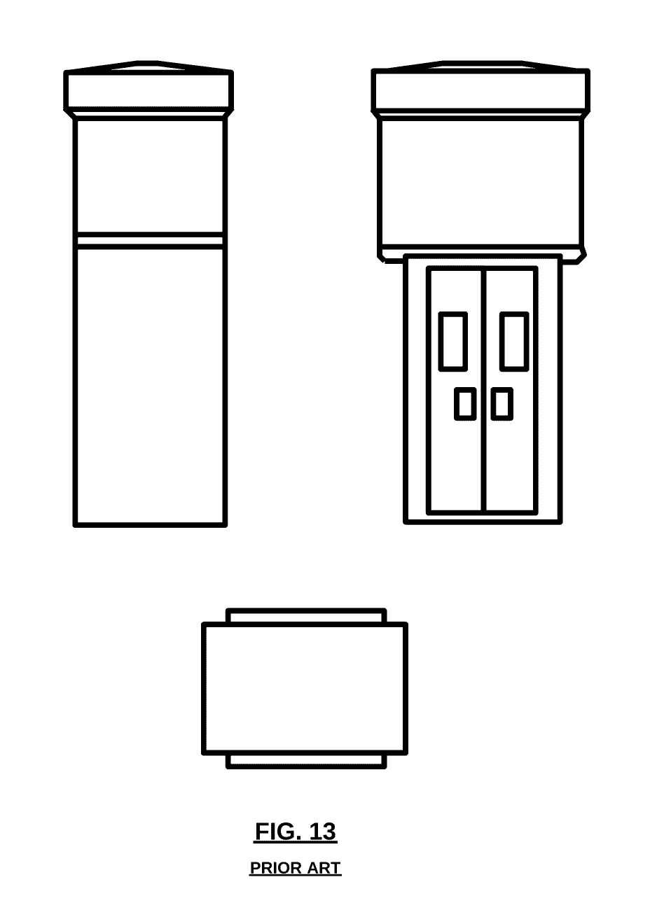

FIGS. 12-13 illustrate safety showers available in the marketplace. The enclosed gravity-fed safety shower depicted in FIG. 13 is relatively small and cannot accommodate additional personnel who may assist the victim. Further, the safety shower includes only one door. The shower cannot be entered from multiple angles, such that additional personnel can quickly and easily access the victim and assist the victim. Further, the shower cubicle does not include a plurality of windows, and therefore the victim cannot be viewed from a plurality of angles by one or more emergency or other personnel.

An embodiment of the disclosure includes a plurality of doors, with at least one door or opening to the safety shower on multiple sides of the shower, each door with at least one visibility/observation window on a plurality of sides so that a victim can be observed by multiple people at different angles to ensure proper safety. The present disclosure is a significant improvement over the prior art because it introduces a plurality of doors that allow assisting personnel to enter and exit the safety shower from different angles and provides multiple entrances on different sides to ensure that the victim can quickly and easily enter the safety shower. Further, the observation windows on a plurality of sides ensures that assisting personnel can view the victim from multiple angles to effectively monitor his progress in operating the shower and thoroughly removing any hazardous chemicals from his body.

One embodiment of the present disclosure includes a shower and eyewash station for one person with additional space to accommodate at least one medical personnel who may assist the victim. Safety showers that can accommodate only the victim are known in the art. Such showers pose a risk to the victim when the victim, often due to the chemical exposure, is unable to e.g. undress himself, wash his eyes and nasal passageway, wash his body, stand, or operate the safety shower. The present disclosure provides a larger safety shower that can accommodate both the victim and additional medical or other personnel who can assist the victim in undressing, operating the shower, thoroughly rinsing the chemical exposure from the victim's body, and verifying that the victim has been effectively washed such that the risk of chemical injury is minimized. This improvement over the prior art can be imperative to saving the victim's life when the victim is e.g. seriously burned or injured, wearing clothing that is difficult or time consuming to remove, is in shock, or is unconscious. Many victims of chemical exposure are at an increased risk of serious injury or death if they cannot be assisted when undressing and washing the chemical exposure from their bodies. It is therefore a critical feature of the present disclosure that the enclosed cubicle is capable of accommodating multiple persons while the shower is operating.

One embodiment of the present disclosure includes a filtration system and/or purification system connected to the liquid supply source for filtering or purifying the liquid. The liquid filtration and/or purification system may filter or purify the liquid by any means known in the art, including, for example, reverse osmosis, charcoal filtration, porous stone filtration, paper or cloth filtration, electronic purification, dissolved oxygen generation, purifying plants, purifying enzymes and/or bacteria, chemical ion exchange purification, and so forth. The filtration and/or purification system may ensure that the liquid is safe to be used to wash off the victim and may ensure that the safety shower remains compliant with government regulations requiring regularly filtered and/or purified liquid.

Another embodiment of the present disclosure is capable of functioning properly at temperatures as low as −40° F. Safety showers must operate in a wide variety of temperatures and weather conditions. For example, oil and gas drilling sites pose numerous chemical risks to personnel and can be found in extreme environments ranging from cold and icy conditions to hot and dry conditions. Safety showers must be constructed such that they can reliably and effectively operate in varying weather conditions. Safety showers are unusable in cold environments and can sustain permanent damage if the liquid is permitted to freeze. Embodiments of the present disclosure may utilize any number of methods to ensure that the liquid does not freeze in cold environments and the safety shower remains function at temperatures as low as −40° F. In one embodiment the safety shower comprises a space heater for heating the interior of the enclosed cubicle, and wherein the space heater may also heat the liquid delivery system and associated pipes such that the liquid does not freeze and the safety shower remains functional. In one embodiment the safety shower comprises a heater for heating the liquid supply source and/or the liquid delivery system. The space heater or heater may be powered by a direct power source, battery power, solar power, wind power, or any other power source known in the art. In one embodiment the space heater or heater may be automatically activated when a thermometer indicates that the safety shower, the liquid supply, or the exterior of the safety shower has reached a specific temperature.

For example, one embodiment of the present disclosure includes at least about 65 mm of Polyurethane insulation in the tank 102 wall of gravity-fed versions. This level of insulation is optimized to prevent the liquid from freezing in cold environments and can also prevent the liquid from overheating in hot environments. Another embodiment includes a heater for the liquid supply. The heater may maintain or heat the liquid to a tepid temperature of about 15 Centigrade to about 38 Centigrade to ensure that the safety shower is comfortable to use and continues to function properly. The heater may be any heater known in the art, including gas, electric, tankless, and steam.

Another embodiment of the disclosure includes a temperature dump valve that will automatically flush the liquid from the shower before the liquid freezes. In one embodiment the temperature dump valve is connected to the gravity-fed liquid supply source located above the enclosed cubicle, and the valve releases the liquid into the shower. In one embodiment the temperature dump valve is electronically connected to a thermometer, and the temperature dump valve is activated when any of the temperature of the liquid, temperature of the interior of the shower, or temperature of the exterior of the shower reaches a threshold level. For example, if the liquid is water with a freezing point of 32° F., then the temperature dump valve may automatically flush the water from the shower when the water reaches, for example, 40° F. The temperature dump valve may also include a sensor for detecting the liquid levels in the shower, and the sensor may be connected to an electronic, audio, or visual alarm that alerts a user when the liquid levels in the shower are below a threshold level. The temperature dump valve is important to the continued functionality of the shower; the shower cannot function if the liquid is frozen and frozen liquid can cause permanent damage to the structure of the shower. In one embodiment, the temperature dump valve may also be manually activated by an individual.

A further embodiment of the disclosure is capable of providing a minimum of 20 minutes of tepid water at 20 gpm for the shower and 0.4 gpm for the eyewash, for a total of 20.4 gpm for the shower and eyewash when used simultaneously. The safety shower in the present disclosure provides an eyewash station and shower capable of providing enough water to safely remove a hazardous chemical from a victim's eyes, nasal passageway, and skin. The present disclosure provides a continuous water flow that can be activated quickly. Further, the water flows to the victim at a tepid temperature of about 15 Centigrade to about 38 Centigrade. The continuous flow of water provided at a tepid temperature is critical to the safe and effective operation of the safety shower. The tepid temperature prevents thermal shock and helps ensure that the victim uses the shower or eyewash station for the full duration of the recommended time. If, for example, the water flows at an uncomfortably cold or hot temperature, the victim may sustain additional injuries or the victim may choose to prematurely discontinue use of the safety shower because the water is flowing at an uncomfortable temperature. This can lead to further injury or even death, and as such, it is a critical portion of the present disclosure that the safety shower is capable of sustaining a continuous flow of tepid water for the minimum time required to safely remove any hazardous chemicals from the victim's body.

The present disclosure can be constructed to use plumbed liquid, a gravity-fed tank housed above the shower, or a remote tank with an in-tank pump that may feed the shower. The plumbed option may be particularly useful indoors, for example in a laboratory or other environment that houses dangerous chemicals. The plumbed option is convenient when the user has access to direct-plumbed water because the shower can have access to a steady flow of water without the need to maintain or fill a tank. The gravity-fed option may be particularly useful at outdoor facilities, for example at an oil and gas withdrawal site. The gravity-fed option utilizes a sufficiently large tank of liquid (most often water) housed above the safety shower. The tank can feed the shower and eyewash station by releasing the liquid and allowing gravity to propel the liquid to the shower and eyewash station. The remote tank may be particularly useful in locations having a low ceiling height that might prohibit the use of an overhead tank.

One embodiment of the present disclosure is a safety shower that is sufficiently large to accommodate a bench or seat 212 (illustrated best in FIG. 2) for the victim to sit on while undressing or operating the safety shower. Victims of chemical injuries are often dressed in multiple layers of clothing and may be wearing footwear that is difficult to remove while standing. Further, victims of chemical injuries may have difficulty standing, may be in shock, and may otherwise require a seat to safely and effectively operate the safety shower. The bench or seat may also be useful to additional medical personnel who must assist the victim in undressing or operating the safety shower. For example, the victim may sit on the bench while additional medical personnel remove his footwear or clothing, and then the additional medical personnel may assist the victim in using the safety shower. The bench or seat may be secured to a wall 202 of the safety shower or may be movable, such that the victim can sit on the bench or seat underneath the shower 206 or while using the eyewash station 208. Further, the bench or seat may be a fixed size and height, may be adjustable to different size and height settings, and may be collapsible such that it can be stored when not needed.

One embodiment of the present disclosure includes a coat rack or hooks 210 for hanging clothing or personal belongings while the safety shower is in use. It may be necessary for the victim or assisting medical personnel to hang personal belongings such that they remain accessible, but do not interfere with safely operating the safety shower and maneuvering within the enclosed cubicle. For example, the coat rack or hooks 210 may be located a sufficient distance away from a door such that assisting personnel entering and exiting the shower do not touch the contaminated clothing. The present disclosure may further include lifting lugs and forklift slots to enable easy shipping and installation of the safety shower. The lifting lugs may be manufactured out of any sufficiently strong and rigid material, and may be manufactured after any manner known in the art.

One embodiment of the present disclosure is constructed to withstand an earthquake when properly installed and anchored. A further embodiment is constructed to withstand a high wind load rating when properly installed and anchored. Safety showers are often installed in environments with earthquakes, storms, and unpredictable weather conditions. It is imperative that the safety shower can remain securely anchored and maintain functionality during and after such environmental activity.

One embodiment of the present disclosure includes a heavy-duty grate on the floor of the safety shower. In a further embodiment, the heavy-duty grate may be luminous at night such that the victim and assisting medical personnel can easily detect the floor of the safety shower. The grate permits easy drainage of used liquid by allowing the liquid to pass through the grate and subsequently exit the shower through a drain. A system for efficient drainage of liquid, such as the heavy-duty grate, is imperative to the safe operation of the safety shower because it allows the victim and assisting personnel to stand on the floor of the safety shower without being at a severe risk of slipping and falling.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited herein.

It is to be understood that the above-described arrangements are only illustrative of the application of the principles of the disclosure. Numerous modifications and alternative arrangements may be devised by those skilled in the art without departing from the spirit and scope of the disclosure and are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A safety shower for washing a user and removing hazardous materials from a user's body, comprising:
an enclosed cubicle having a plurality of walls, wherein the enclosed cubicle is configured to accommodate a user and at least one additional person to assist the user;
a liquid delivery system located within the enclosed cubicle and configured to wash the user, wherein the liquid delivery system comprises at least one of a showerhead and an eyewash station;
a liquid supply source to supply a liquid to the liquid delivery system, wherein the liquid supply source comprises at least one of a tank and a directly plumbed liquid supply;
a plurality of doors for entering and exiting the safety shower; and
a plurality of windows for monitoring an interior of the enclosed cubicle.

2. The safety shower of claim 1, wherein the plurality of doors are each located on different sides of, and at an angle with respect to, the enclosed cubicle thereby allowing assisting personnel to enter and exit the safety shower from a plurality of angles and to allow multiple entrances on different sides of the cubicle to ensure that the user can quickly and easily enter the safety shower.

3. The safety shower of claim 1, wherein the plurality of windows are located on a plurality of sides of the enclosed cubicle for assisting personnel to view the user from a plurality of angles to thereby monitor the user's progress in operating the shower and removing any hazardous materials from the user's body.

4. The safety shower of claim 1, wherein the enclosed cubicle comprises at least five walls, and wherein at least two of the walls further comprises a door.

5. The safety shower of claim 1, further comprising a liquid supply indicator configured to display the quantity of liquid contained within the liquid supply source.

6. The safety shower of claim 1, further comprising a heater configured to heat the liquid to a tepid temperature of about 15 Centigrade to about 38 Centigrade.

7. The safety shower of claim 1, further comprising a pre-cast base connected to and supporting the enclosed cubicle.

8. The safety shower of claim 7, wherein the pre-cast base is constructed of cement reinforced with steel rebar.

9. The safety shower of claim 7, wherein the pre-cast base further comprises an electrical heat tray within the cement.

10. The safety shower of claim 7, wherein the pre-cast base is configured to drain used liquid that has passed through the liquid delivery system.

11. The safety shower of claim 1, further comprising a seat within the enclosed cubicle.

12. The safety shower of claim 1, further comprising an audio and visual alarm attached to an exterior of the enclosed cubicle, wherein the alarm is configured to activate simultaneously when the liquid delivery system is activated.

13. The safety shower of claim 1, wherein at least one of the plurality of doors is a double swing door.

14. The safety shower of claim 1, further comprising a temperature dump valve configured to automatically flush the liquid when the liquid approaches a freezing temperature.

15. The safety shower of claim 1, wherein the liquid delivery system comprises a shower and an eyewash station, and the shower provides a minimum of fifteen minutes tepid water at about 20 gpm and the eyewash station provides a minimum of fifteen minutes tepid water at about 0.4 gpm.

16. The safety shower of claim 1, further comprising a liquid filtration system configured to filter the liquid before it passes through the liquid delivery system.

17. The safety shower of claim 1, wherein the enclosed cubicle is configured to withstand a wind speed of at least 35 miles per hour.

18. The safety shower of claim 1, wherein the enclosed cubicle comprises six walls and wherein at least two of the walls further comprise a door such that assisting personnel may enter or exit the safety shower from a plurality of angles.

19. The safety shower of claim 1, wherein the enclosed cubicle comprises eight walls and wherein at least three of the walls further comprise a door such that assisting personnel may enter or exit the safety shower from a plurality of angles.

20. A safety shower for washing a user and removing hazardous materials from a user's body, comprising:
an enclosed cubicle having a plurality of walls, wherein the enclosed cubicle is configured to accommodate a user and at least one additional person to assist the user;
a liquid delivery system located within the enclosed cubicle, wherein the liquid delivery system comprises at least one of a showerhead and an eyewash station;
a liquid supply source to supply a liquid to the liquid delivery system, wherein the liquid supply source comprises at least one of a tank and a direct-plumbed liquid supply;
a liquid filtration system connected to the liquid supply source and configured to filter the liquid before it passes through the liquid delivery system;
a plurality of doors for entering and exiting the safety shower, wherein the plurality of doors are each located on different sides of, and at an angle with respect to, the enclosed cubicle thereby allowing assisting personnel to enter and exit the safety shower from a plurality of angles and to allow multiple entrances on different sides of the cubicle to ensure that the user can quickly and easily enter the safety shower;
a plurality of windows, wherein the windows are located on the plurality of sides of the enclosed cubicle for assisting personnel to view the user from a plurality of angles to thereby monitor the user's progress in operating the shower and removing any hazardous materials from the user's body;
a heater configured to heat the liquid to a tepid temperature of about 15 Centigrade to about 38 Centigrade;
an audio and visual alarm attached to an exterior of the enclosed cubicle;
a temperature dump valve configured to automatically flush the liquid when the liquid approaches a freezing temperature; and
a pre-cast base connected to and supporting the enclosed cubicle.
